(19) United States
(12) Patent Application Publication
(10) Pub. No.: US 2019/0329732 A1
(43) Pub. Date: Oct. 31, 2019

(54) Method for Safeguarding Access

(71) Applicant: Bayerische Motoren Werke Aktiengesellschaft, Muenchen (DE)

(72) Inventors: Fredrik HOCKE, Muenchen (DE); Daniel KNOBLOCH, Muenchen (DE); Helmut WAGATHA, Oberschleissheim (DE)

(21) Appl. No.: 16/508,025

(22) Filed: Jul. 10, 2019

Related U.S. Application Data
(63) Continuation of application No. PCT/EP2017/079109, filed on Nov. 14, 2017.

(30) Foreign Application Priority Data
Jan. 17, 2017 (DE) 10 2017 200 668.4

(51) Int. Cl. B60R 25/24

(52) U.S. Cl. CPC B60R 25/245; B60R 25/209; B60R 2325/105

(57) ABSTRACT

A method for controlling access to a system by means of an identification (ID) transmitter, wherein the ID transmitter is authenticated by virtue of a distance between the ID transmitter and a reference point in the system being checked by transmitting a radio signal, includes receiving a first version of the radio signal at a first time and a second version of the radio signal at a second time. The method also includes determining, based on the first time and on the second time, whether the second version of the radio signal is a relay signal generated from the radio signal as part of a relay attack, and prompting a measure to prevent access to the system if it is determined that the second version of the radio signal is the relay signal.

### CROSS REFERENCE TO RELATED APPLICATIONS

This application is a continuation of PCT International Application No. PCT/EP2017/079109, filed Nov. 14, 2017, which claims priority under 35 U.S.C. § 119 from German Patent Application No. 10 2017 200 668.4, filed Jan. 17, 2017, the entire disclosures of which are herein expressly incorporated by reference.

### BACKGROUND AND SUMMARY OF THE INVENTION

The invention relates to a method for protecting keyless access, in particular to a motor vehicle.

Keyless access functions for a system (e.g. for a motor vehicle) are frequently based on the authentication of an ID transmitter in a locally limited area. A user carries an ID transmitter (e.g. a key) on him. The ID transmitter authenticates itself to an access control unit of a system via a radio connection. In addition, a suitable radio protocol is used to measure the distance of the ID transmitter from one or more reference points in the system. Based on the correct authentication key and based on a defined distance from the one or more reference points in the system, access to the system is then granted or denied.

Access functions of this kind can be susceptible to what are known as relay attacks. If the ID transmitter is not at the defined distance from the one or more reference points, an attacker can place a first relay device close to the ID transmitter and a second relay device close to the one or more reference points and forward a radio signal of the ID transmitter to the system via the relay devices. To this end, at both ends of the relay link, the radio signal can be received in a frequency band of the ID transmitter, transmitted to the other end of the relay link via a separate (radio) channel and emitted in the frequency band of the ID transmitter again at the respective end of the relay link. The radio protocol for distance measurement can thus be given the impression that the ID transmitter is within the defined distance from the one or more reference points in the system.

The present disclosure is concerned with the technical object of providing an efficient method for reliably protecting a keyless access function.

According to one aspect, a method for controlling the access to a system (in particular to a vehicle) by means of an ID transmitter (e.g. by means of a radio key) is described. This involves the ID transmitter being authenticated by virtue of the distance between the ID transmitter and a reference point in the system being checked by transmitting a radio signal. Typically, access to the system is not granted if it is ascertained that the ID transmitter is at a distance from the reference point in the system that is above a particular distance threshold value (e.g. of 1-3 m). To authenticate the ID transmitter, it is therefore possible to check whether the ID transmitter is within a particular distance from the reference point in the system (in particular in a vehicle). If the ID transmitter has been authenticated, access to the system can be granted. In particular, e.g. the unlocking of a door of a vehicle and/or the starting of an engine of a vehicle can be rendered possible on the basis of the successful authentication of the ID transmitter.

The radio signal can have a radio signal having a range in the region of 30-100 m. An exemplary radio signal is a Bluetooth Low Energy (BLE) radio signal.

The method comprises receiving a first version of the radio signal at a first time and a second version of the radio signal at a second time. In this case, both versions of the radio signal can have a standard identifier allowing a receiver of the two versions of the radio signal to detect that the received radio signals are different versions or instances of the same radio signal.

Additionally, the method comprises determining, on the basis of the first time and on the basis of the second time (in particular on the basis of a period of time between the first time and the second time), whether the second version of the radio signal is a relay signal generated from the radio signal as part of a relay attack. Alternatively, the second version of the radio signal could be a reflection of the radio signal.

The determining of whether the second version of the radio signal is a relay signal can comprise the ascertaining of a period of time between the first time and the second time and the comparing of the period of time with a time threshold value. The time threshold value in this case can be dependent on typical delay times for the radio signal, which delay times can arise on account of reflections of the radio signal.

It is possible to determine that the second version of the radio signal is a relay signal if the period of time is above the time threshold value. On the other hand, it is possible to determine that the second version of the radio signal is not a relay signal and/or that the second version of the radio signal is a reflection of the radio signal if the period of time is below the time threshold value. This allows the presence of a relay attack to be detected in an efficient and reliable manner.

The method can comprise the ascertaining of a first signal strength of the first version of the radio signal and of a second signal strength of the second version of the radio signal. It is then possible for the first signal strength and the second signal strength to also be taken as a basis for determining whether or not the second version of the radio signal is a relay signal. In particular, it is possible to ascertain whether the first signal strength is below the second signal strength, and whether the second time follows the first time. If this is the case, it is possible to determine in a reliable that the second version of the radio signal is a relay signal (since typically a reflected radio signal should have a reduced signal strength in comparison with the directly received radio signal).

Additionally, the method can comprise the prompting of a measure to prevent the access to the system if it is determined that the second version of the radio signal is a relay signal (even if it is ascertained that the ID transmitter is within the permissible distance from the reference point in the system). Therefore, the security of a keyless access function for a system can be increased in an efficient and reliable manner.

The radio signal can comprise an enquiry signal sent from a transmission unit of the system to the ID transmitter (e.g. using a BLE radio protocol). The transmission unit may be arranged at the reference point in the system. A signal strength of the enquiry signal received at the ID transmitter can be used to determine the distance between the ID transmitter and the reference point. Information concerning the signal strength or concerning the distance can then be sent from the ID transmitter to a reception unit of the system using a response signal.

The method described in this document can therefore be carried out at least in part by the ID transmitter. The prompting of a measure to prevent the access to the system can then comprise the preventing of the transmitting of a response signal in reaction to the enquiry signal. In the absence of a response signal, the ID transmitter cannot be authenticated by the system. Consequently, access to the system can be prevented.

Alternatively or additionally, the radio signal can comprise a response signal (e.g. in the HF frequency range) sent from the ID transmitter to the system in reaction to an enquiry signal of a transmission unit of the system. The method can then be carried out at least in part by the system. The prompting of a measure to prevent the access can then comprise the rejecting of the authentication of the ID transmitter (even it has been ascertained that the ID transmitter is at a reliable distance from the reference point) and/or the outputting of advice via an output unit (e.g. via a loudspeaker) of the system.

According to a further aspect, a control unit is described that is configured to carry out the method described in this document.

According to a further aspect, a vehicle (in particular a road motor vehicle, e.g. a passenger vehicle, a truck or a motorcycle) and/or an ID transmitter are described that comprise the control unit described in this document.

According to a further aspect, a software (SW) program is described. The SW program can be configured to be executed on a processor and to thereby carry out the method described in this document.

According to a further aspect, a storage medium is described. The storage medium can comprise an SW program configured to be executed on a processor and to thereby carry out the method described in this document.

It should be noted that the methods, apparatuses and systems described in this document can be used either alone or in combination with other methods, apparatuses and systems described in this document. In addition, any aspects of the methods, apparatuses and systems described in this document can be combined with one another in a wide variety of ways. In particular, the features of the claims can be combined with one another in a wide variety of ways.

Other objects, advantages and novel features of the present invention will become apparent from the following detailed description of one or more preferred embodiments when considered in conjunction with the accompanying drawings.

### BRIEF DESCRIPTION OF THE DRAWINGS

The invention is described more specifically below on the basis of exemplary embodiments with reference to the following figures:

FIG. 1a shows an exemplary vehicle having an access control function.

FIG. 1b shows an exemplary ID transmitter.

FIG. 2 shows a scenario for an exemplary relay attack.

FIG. 3 shows a flowchart for an exemplary method for controlling the access to a system, in particular to a motor vehicle.

### DETAILED DESCRIPTION OF THE DRAWINGS

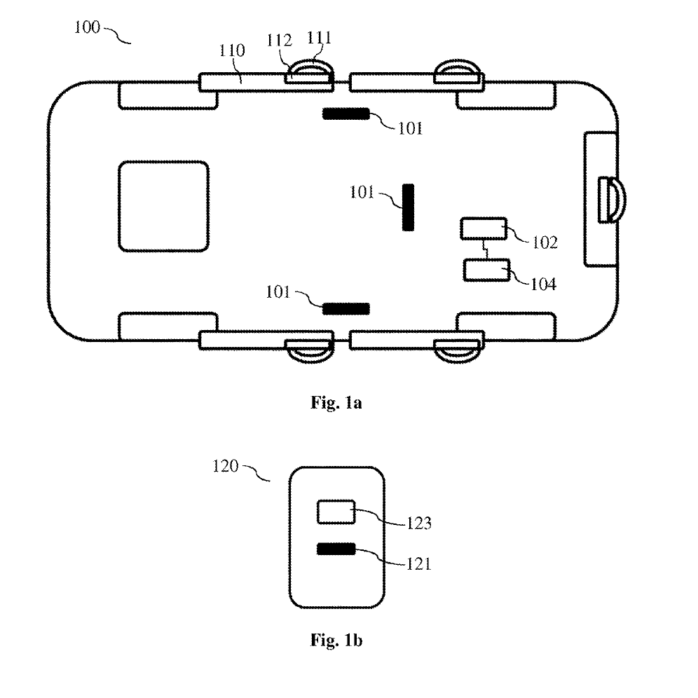

As set out in the introduction, the present document is concerned with the provision of a keyless access function that is protected against relay attacks in a reliable manner. FIG. 1a shows an exemplary vehicle 100 and FIG. 1b shows an exemplary ID transmitter 120 that provide a keyless access function. A keyless access function allows a driver of a vehicle 100 to open a vehicle door 110 or to start the engine of the vehicle 100 without using the key/lock principle. To open the door 110, the driver grasps the door handle 111. A proximity sensor 112 on or close to the door handle 111 detects this movement. A specific radio signal (e.g. in the LF, low frequency, range or using a Bluetooth Low Energy, BLE, radio protocol) is then sent using one or more transmission units 101 of the vehicle 100. This radio signal can also be referred to as an enquiry signal. In other words, the one or more transmission units 101 may be configured to transmit an electromagnetic field, i.e. the enquiry signal. Exemplary transmission frequencies of the one or more transmission units 101 are in the frequency range of 20-140 kHz (e.g. 20 kHz, 124 kHz, 125 kHz, 127 kHz, 133 kHz or 135 kHz). Alternatively, frequencies in the region of 2.4 GHz (e.g. when using BLE) can be used (in order to allow greater ranges).

The electromagnetic field transmitted by the one or more transmission units 101 comprises the enquiry signal. The transmitted enquiry signal can comprise multiple portions. A first portion of the enquiry signal may be designed to wake a reception unit 123 in an ID transmitter 120 (e.g. a key) of the driver, i.e. to prepare it for receiving further information. A further portion of the enquiry signal can comprise information for identifying the vehicle 100 and/or for uniquely identifying the enquiry signal. The different portions of the enquiry signal transmitted by the one or more transmission units 101 can be sent with staggered timing.

The reception unit 123 in the ID transmitter 120 is configured to receive the signals or signal portions sent by the one or more transmission units 101 and to ascertain the signal strength or field strength of the signals or signal portions. A transmission unit 121 of the ID transmitter 120 responds to the received enquiry signal with a response signal. The response signal can be transmitted in a different frequency range than the enquiry signal. By way of example, the response signal can be transmitted at a response frequency of 433 MHz (i.e. in the HF (high frequency) range). Alternatively, frequencies in the region of 2.4 GHz (e.g. when using BLE) can be used.

The response signal can consist of multiple portions. A first portion of the response signal can be used for identifying the ID transmitter 120 and a further portion of the response signal can comprise information for the measured signal strength of the enquiry signal. One or more reception units 104 of the vehicle 100 can receive the response signal and/or the response signal portions and forward it/them to a control unit 102 of the vehicle 100. The control unit 102 may be configured to check whether the ID transmitter 120 fits the vehicle 100. In addition, triangulation or a lookup table can be used to calculate the position of the ID transmitter 120 relative to the vehicle 100 (on the basis of the measured signal strengths of a plurality of enquiry signals). If the estimated position of the ID transmitter 120 matches the position of the proximity sensor 112 (e.g. surroundings of the touched door 110 and/or of the touched door handle 111), then the door 110 and/or the whole vehicle 100 are opened. The ID transmitter 120 has therefore been authenticated.

As depicted in FIG. 1a, the vehicle 100 typically comprises a plurality of transmission units 101. The transmission units 101 may be arranged at different locations (i.e. reference points) in the vehicle 100. Each transmission unit 101 of the plurality of transmission units 101 can send an enquiry signal (e.g. a signal pulse). The enquiry signals may be staggered over time, and may possibly be in a predefined order. Alternatively or additionally, the enquiry signals can have a unique identifier. The ID transmitter 120 and/or the reception unit 104 of the vehicle 100 can use the identifier and/or the order to uniquely associate the enquiry signals with a respective transmission unit 101 of the plurality of transmission units 101. Therefore, the respective signal strength of the individual enquiry signals and hence also the respective distance between transmission unit 101 (i.e. reference point) and ID transmitter 120 can be ascertained. Since the transmission units 101 are at different locations (i.e. reference points) in the vehicle 100, a plurality of distances is thus obtained for the applicable plurality of transmission units 101. Triangulation methods can thus be used to determine the relative position between vehicle 100 and ID transmitter 120. If need be, an orientation of the vehicle 100 in relation to the ID transmitter 120 can also be determined.

The aforementioned procedure for identity matching/position matching between vehicle 100 and ID transmitter 120 typically takes a period of approximately 100 ms. That is to say that the aforementioned procedure is typically unnoticed by the driver on account of the short period, which means that the driver can open the door 110 directly by grasping the door handle 111. An analogous procedure for identity matching/position matching typically also takes place when the engine is started.

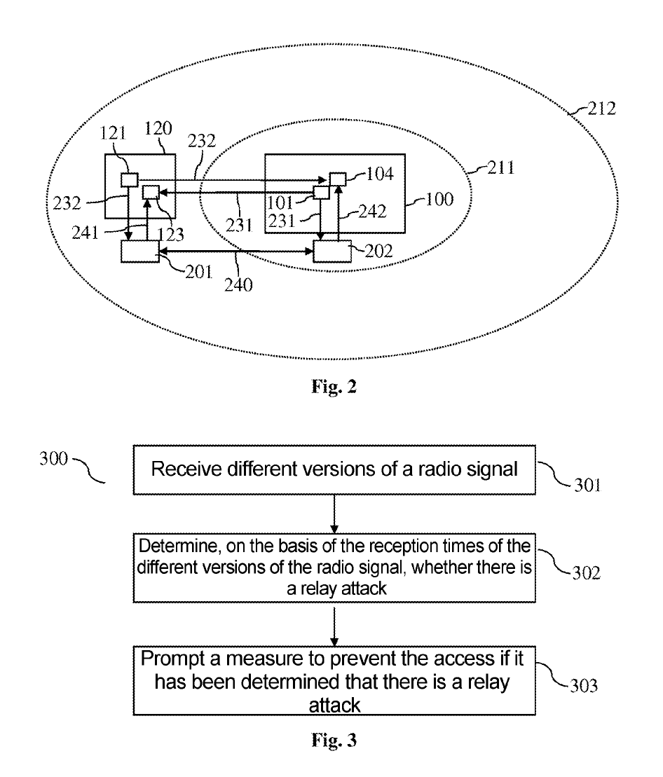

FIG. 2 shows a scenario for a relay attack, in which a first relay device 201 is arranged close to the ID transmitter 120 and in which a second relay device 202 is arranged close to the vehicle 100. In the example depicted in FIG. 2, a maximum distance 211 between ID transmitter 120 and vehicle 100 is permissible for authenticating an ID transmitter 120. In addition, and a radio signal 231, 232 (e.g. an enquiry signal 231 or a response signal 232) exchanged between vehicle 100 and ID transmitter 120 has a range 212.

The enquiry signal 231 transmitted by a transmission unit 101 of the vehicle 100 can be received by the second relay device 202 and forwarded to the first relay device 201 via a relay radio link 240. A relay signal 241 corresponding to the enquiry signal 231 can then be transmitted by the first relay device 201 and received by the reception unit 123 of the ID transmitter 120. The transmission unit 121 of the ID transmitter 120 can then transmit a response signal 232, which can be received by the first relay device 201 and forwarded to the second relay device 202 via the relay radio link 240. The second relay device 202 can then transmit a relay signal 242 corresponding to the response signal 232, which relay signal can be received by the reception unit 104 of the vehicle 100. The vehicle 100 can thus be provided with the impression that the ID transmitter 120 is in direct proximity (i.e. within the maximum distance 211) to the vehicle 100.

One way of detecting such a relay attack is to use a time-of-flight measurement. This can result in the time needed by a radio signal 231, 232 between ID transmitter 120 and vehicle 100 being measured. Owing to the processing within the relay devices 201, 202, the transmission of an applicable relay signal 241, 242 via the relay radio link 240 typically results in delays that can be detected at the ID transmitter 120 and/or at the vehicle 100. Such measurements of the time of flight of a radio signal are typically relatively complex, however.

Radio protocols for distance measurement with a relatively long range 212 typically result in the ID transmitter 120 and/or the vehicle 100 receiving both the direct radio signal 231, 232 and the relay signal 241, 242 in the event of a relay attack. In particular, the ID transmitter 120 can receive both the direct enquiry signal 231 and the corresponding relay signal 241. Alternatively or additionally, the vehicle 100 can receive both the direct response signal 232 and the corresponding relay signal 242. The reception of (at least) two versions of a radio signal can be used by the receiving unit 100, 120 to detect a relay attack.

As already set out above, the reception unit 123 in the ID transmitter 120 may be configured to ascertain the signal strength or field strength of a received enquiry signal 231. If multiple versions of an enquiry signal 231 are received, then, if need be, the version of the enquiry signal 231 having the lower signal strength (and therefore having the greater distance) can be considered to be a reflection of the version of the enquiry signal 231 having the higher signal strength (and therefore having the greater distance).

In order to be able to distinguish the reflection of an enquiry signal 231 from the generation of a relay signal 241, the period between the first reception time of a first version of the enquiry signal 231 (having a particular identifier) and the second reception time of a second version of the enquiry signal 231 (having the particular identifier) can be considered. If the same radio signal 231 having the same identifier is received twice with a time delay, a time threshold value for a plausible period of time for a reflection can be used to decide whether or not the double reception is a reflection. If the period of time is too long, a relay attack can be assumed and the ID transmitter 120 can react accordingly (e.g. preventing transmission of a response signal 232).

Accordingly, the vehicle 100, on repeatedly receiving a response signal 232 having the same identifier, is able, by ascertaining the period of time between reception of the two versions of the response signal 232 and by comparing it with a time threshold value, to ascertain whether the repeated reception is a reflection or a relay attack. If there is a relay attack, the vehicle 100 can react accordingly (e.g. outputting a warning and/or rejecting the authentication of the ID transmitter 120).

FIG. 3 shows a flowchart for an exemplary method 300 for controlling the access to a system 100 by means of an ID transmitter 120. In this case, the system 100 can be a vehicle. In particular, the unlocking of a door 111 of a vehicle and/or the starting of an engine of the vehicle can be controlled. To authenticate the ID transmitter 120, the distance between the ID transmitter 120 and a reference point in the system 100 (e.g. in a transmission unit 101) can be checked by transmitting a radio signal 231, 232. By way of example, an enquiry signal 231 can be transmitted from a transmission unit 101 of the system 100 to the ID transmitter 120. Alternatively or additionally, a response signal 232 can be sent from the ID transmitter 120 to the system 100.

The method 300 comprises receiving 301 a first version of the radio signal 231, 232 at a first (reception) time and a second version of the radio signal 231, 232 at a second (reception) time. In this case, both versions of the radio signal 231, 232 can have the same identifier.

Additionally, the method 300 comprises determining 302, on the basis of the first time and on the basis of the second time, whether or not the second version of the radio signal 231, 232 is a relay signal 241, 242 generated from the radio signal 231, 232 as part of a relay attack. In particular, the period of time between the first time and the second time can be taken as a basis for ascertaining whether or not the second version of the radio signal 231, 232 is a relay signal 241, 242.

The method 300 further comprises prompting 303 a measure to prevent the access to the system 100 if it is determined that the second version of the radio signal 231, 232 is a relay signal 241, 242 (even if it is ascertained that the ID transmitter 120 is at a permissible distance from the reference point).

The method 300 therefore allows reliable and efficient protection against relay attacks for keyless access functions, in particular when long range radio technologies are used, such as e.g. BLE (Bluetooth Low Energy), for transmitting the radio signals 231, 232 (from the system 100 to the ID transmitter 120 and/or from the ID transmitter 120 to the system 100).

The present invention is not restricted to the exemplary embodiments shown. In particular, it should be noted that the description and the figures are only intended to illustrate the principle of the proposed methods, apparatuses and systems.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for controlling access to a system by means of an identification (ID) transmitter, wherein the ID transmitter is authenticated by virtue of a distance between the ID transmitter and a reference point in the system being checked by transmitting a radio signal, wherein the method comprises:
receiving a first version of the radio signal at a first time and a second version of the radio signal at a second time;
determining, based on the first time and on the second time, whether the second version of the radio signal is a relay signal generated from the radio signal as part of a relay attack; and
prompting a measure to prevent access to the system if it is determined that the second version of the radio signal is the relay signal.

2. The method according to claim 1, wherein said determining of whether the second version of the radio signal is the relay signal comprises:
ascertaining a period of time between the first time and the second time; and
comparing the period of time with a time threshold value.

3. The method according to claim 2, wherein
it is determined that the second version of the radio signal is a relay signal if the period of time is above the time threshold value; and/or
it is determined that the second version of the radio signal is not a relay signal and/or that the second version of the radio signal is a reflection of the radio signal if the period of time is below the time threshold value.

4. The method according to claim 1, wherein the method further comprises ascertaining a first signal strength of the first version of the radio signal and a second signal strength of the second version of the radio signal, and
wherein determining whether the second version of the radio signal is the relay signal is further based on the first signal strength and the second signal strength.

5. The method according to claim 2, wherein the method further comprises ascertaining a first signal strength of the first version of the radio signal and a second signal strength of the second version of the radio signal, and
wherein determining whether the second version of the radio signal is the relay signal is further based on the first signal strength and the second signal strength.

6. The method according to claim 3, wherein the method further comprises ascertaining a first signal strength of the first version of the radio signal and a second signal strength of the second version of the radio signal, and
wherein determining whether the second version of the radio signal is the relay signal is further based on the first signal strength and the second signal strength.

7. The method according to claim 4, wherein said determining whether the second version of the radio signal is the relay signal further comprises:
ascertaining whether the first signal strength is below the second signal strength; and
ascertaining whether the second time follows the first time.

8. The method according to claim 5, wherein said determining whether the second version of the radio signal is the relay signal further comprises:
ascertaining whether the first signal strength is below the second signal strength; and
ascertaining whether the second time follows the first time.

9. The method according to claim 6, wherein said determining whether the second version of the radio signal is the relay signal further comprises:
ascertaining whether the first signal strength is below the second signal strength; and
ascertaining whether the second time follows the first time.

10. The method according to claim 1, wherein
the radio signal comprises an enquiry signal sent from a transmission unit of the system to the ID transmitter and
the method is carried out at least in part by the ID transmitter.

11. The method according to claim 2, wherein
the radio signal comprises an enquiry signal sent from a transmission unit of the system to the ID transmitter and
the method is carried out at least in part by the ID transmitter.

12. The method according to claim 3, wherein
the radio signal comprises an enquiry signal sent from a transmission unit of the system to the ID transmitter and
the method is carried out at least in part by the ID transmitter.

13. The method according to claim 4, wherein
the radio signal comprises an enquiry signal sent from a transmission unit of the system to the ID transmitter and
the method is carried out at least in part by the ID transmitter.

14. The method according to claim 10, wherein said prompting of the measure comprises preventing transmission of a response signal for the enquiry signal.

15. The method according to claim 1, wherein
the radio signal comprises a response signal sent from the ID transmitter to the system in response to an enquiry signal of a transmission unit of the system; and
the method is carried out at least in part by the system.

16. The method according to claim 4, wherein
the radio signal comprises a response signal sent from the ID transmitter to the system in response to an enquiry signal of a transmission unit of the system; and
the method is carried out at least in part by the system.

17. The method according to claim 15, wherein said prompting of the measure comprises:
rejecting the authentication of the ID transmitter; and/or
outputting advice via an output unit of the system.

18. The method according to claim 1, wherein
the system comprises a vehicle; and/or
access to the system comprises unlocking a door of the vehicle and/or starting an engine of the vehicle.
